(19) United States
(12) Patent Application Publication
(10) Pub. No.: US 2015/0268991 A1
(43) Pub. Date: Sep. 24, 2015

(54) METHOD AND APPARATUS FOR MANAGING THE SCHEDULING OF UNSCHEDULED EVENTS

(71) Applicant: MOTOROLA MOBILITY LLC, Chicago, IL (US)

(72) Inventors: Amit Kumar Agrawal, Bangalore (IN); Abhijith Krisnappa, Bangalore (IN); Karthik Kumar, Bangalore (IN)

(73) Assignee: MOTOROLA MOBILITY LLC, Chicago, IL (US)

(21) Appl. No.: 14/219,098

(22) Filed: Mar. 19, 2014

(51) Int. Cl. G06F 9/48; G06F 9/50

(52) U.S. Cl. CPC G06F 9/4881; G06F 9/5094; G06F 2209/5021; G06F 2209/486

(57) ABSTRACT

A method and apparatus for managing the scheduling of unscheduled events includes an electronic device detecting an indication of an unscheduled event for a first time period and determining that a remaining charge for the electronic device is insufficient to complete the unscheduled event during the first time period. The method further includes the electronic device determining a set of options for managing the unscheduled event based on the remaining charge and presenting the set of options using the electronic device.

### FIELD OF THE DISCLOSURE

The present disclosure relates generally to an electronic device managing the scheduling of unscheduled events and more particularly to the electronic device managing the scheduling of unscheduled events that involve the use of the electronic device based on an amount of charge available to the electronic device.

### BACKGROUND

Mobile electronic devices having self-contained power sources, such as smartphones and tablets, continue to evolve through increasing levels of performance and functionality as manufacturers design feature-rich products that offer consumers greater convenience and productivity. Today, a single smartphone can operate as a phone, two-way radio, media player, web browser, global-positioning-system receiver, camera, personal digital assistant, gaming device, and remote control where separate, dedicated devices would have been required at the turn of the century.

These numerous features mean that mobile electronic devices are now relied on more frequently by their users to perform daily tasks. Further, users can stay connected and conduct business even when not at home or in the office. Frequent use of a mobile electronic device, however, reduces the amount of time a charge of the device lasts to support tasks and events for which the device is needed.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an illustration of an electronic device in accordance with some embodiments of the present teachings.

FIG. 2 is a block diagram of an electronic device in accordance with some embodiments of the present teachings.

FIG. 3 is a logical flowchart depicting a method for managing the scheduling of an unscheduled event in accordance with some embodiments of the present teachings.

FIG. 4 is a schematic diagram depicting options for scheduling an unscheduled event in accordance with some embodiments of the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. In addition, the description and drawings do not necessarily require the order presented. It will be further appreciated that certain actions and/or steps may be described or depicted in a particular order of occurrence while those skilled in the art will understand that such specificity with respect to sequence is not actually required.

The apparatus and method components have been represented, where appropriate, by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to various embodiments described herein, the present disclosure provides a method and apparatus for managing the scheduling of unscheduled events whereby an electronic device manages the scheduling of unscheduled events involving the use of the electronic device based on an amount of charge available to the electronic device for performing the unscheduled events. Included in managing the scheduling of unscheduled events based on an available charge is intelligently scheduling unscheduled events so that they can be completed, and not scheduling unscheduled events that cannot be completed. In accordance with the teachings herein is a method performed by an electronic device to manage scheduling of unscheduled events that includes the electronic device detecting an indication of an unscheduled event for a first time period and determining that a remaining charge for the electronic device is insufficient to complete the unscheduled event during the first time period. The method further includes the electronic device determining a set of options for managing the unscheduled event based on the remaining charge and presenting the set of options using the electronic device.

Also in accordance with the teachings herein is an electronic device configured to manage scheduling of new events. The electronic device includes a user interface and a self-contained power source configured to power the electronic device. The electronic device further includes a processing element coupled to the self-contained power source and the user interface, wherein the processing element is configured to detect an indication of an unscheduled event for a first time period and determine that a remaining charge for the self-contained power source is insufficient to complete the unscheduled event during the first time period. The processing element is further configured to determine a set of options for managing the unscheduled event based on the remaining charge and to present the set of options and receive a user-selected option from the set of options using the user interface.

In one embodiment, the electronic device further includes a receiver element coupled to the processing element, wherein the receiver element is configured to receive the indication of the unscheduled event from an external device. The processing element is also further configured to schedule the unscheduled event in response to receiving the user-selected option, which confirms the scheduling of the unscheduled event.

In another embodiment, the electronic device further includes a transmitter element coupled to the processing element, wherein the transmitter element is configured to transmit the indication of the unscheduled event to an external device. In a further embodiment, the processing element of the electronic device is also configured to control the transmitter element to transmit the indication of the unscheduled event to the external device in response to the user-selected option, which confirms scheduling of the unscheduled event.

In an additional embodiment, the processing element of the electronic device is further configured to perform a user-selected option from the set of options for managing the unscheduled event. Here, the user-selected option includes one of: declining to schedule the unscheduled event; delegating the unscheduled event to another electronic device; scheduling the unscheduled event for a second time period before the first time period when the remaining charge for the electronic device is sufficient to complete the unscheduled event; or scheduling the unscheduled event for a second time period after the first time period based on the availably of a charging opportunity after the first time period.

For a particular embodiment, the processing element of the electronic device is also configured to perform a user-selected option from the set of options for managing the unscheduled event. Here, the user-selected option includes at least one of: altering a characteristic of the unscheduled event to reduce power consumption of the unscheduled event; altering a characteristic of a first scheduled event prior to the unscheduled event to reduce power consumption of the scheduled event; or unscheduling a second scheduled event prior to the unscheduled event to reduce power consumption of the electronic device.

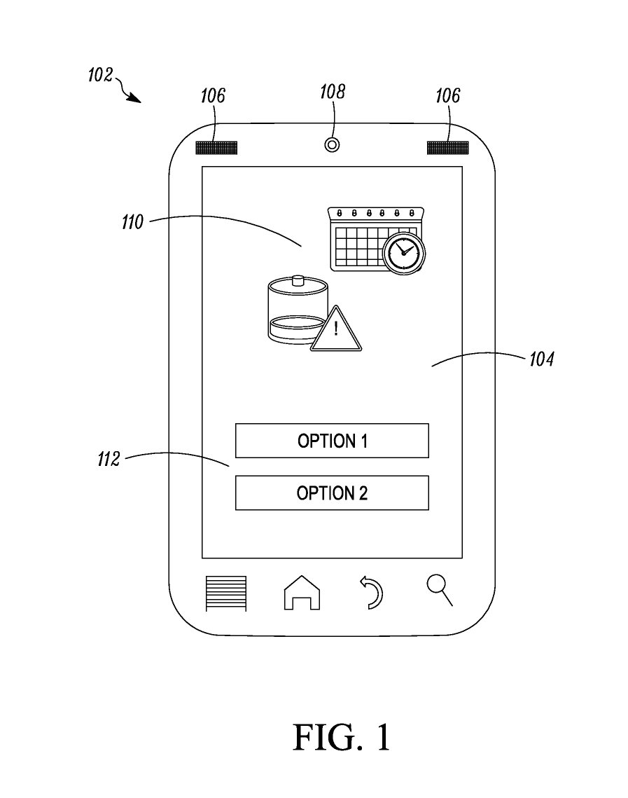

Referring now to the drawings, and in particular FIG. 1, an electronic device (also referred to herein simply as a “device”) implementing embodiments in accordance with the present teachings is shown and indicated generally at 102. Specifically, device 102 represents a smartphone that includes: a touchscreen 104, speakers 106, and a microphone 108. While two stereo speakers 106 and a single monaural microphone 108 are shown for the device 102, other devices consistent with the teachings herein may have different numbers of speakers and/or microphones including devices with no speakers and/or microphones. Being displayed by the touchscreen 104 is an icon 110 for an unscheduled event and a set of options 112 for managing the unscheduled event when a charge for the device 102 is too low to complete the unscheduled event during a time period for which the event is intended.

An “event,” as used herein, is defined to be an occurrence or activity that involves the use of an electronic device at an arranged time. For instance, a video conference is an event that allows participants to remotely meet at a particular time using, for instance, a video conferencing application within the participants' respective electronic devices. An unscheduled event is an event that is intended or proposed for a time that has not yet been accepted or committed to. Upon acceptance or commitment to a time for an event, whether it is the initially intended or proposed time, or an alternate time, the event transitions from an unscheduled event to a scheduled event.

In a first example, a device detects an incoming invitation, such as a calendar invitation, from a peer device for a video conference at a proposed time of 10:00 ante meridiem (AM). In an embodiment, the invitation is addressed to an intended participant who is a user of the device that detected the invitation. The event is the video conference, which is unscheduled for the user at the time the invitation is received. If the user uses his device to accept (e.g., calendar) the invitation for 10:00 AM, then the video conference becomes a scheduled event. Alternatively, the user may decline the invitation or propose the video conference be scheduled at a different time.

In a second example, the user uses his device to generate an outgoing invitation for a video conference at a proposed time of 2:00 post meridiem (PM). Before the user sends the invitation to one or more peer devices, the video conference is an unscheduled event. When the user commits to the proposed time by sending the invitation to the one or more peer devices, the video conference becomes a scheduled event, which is maintained, for instance on one or more calendars of the user, by device that sends the invitation. Although the video conference is scheduled on the sending device after the invitation is sent, it is not scheduled on a recipient device until the recipient accepts the invitation. In one embodiment, if all recipients decline the invitation, then the event is no longer scheduled for the user who sent the invitation. As the invitation is pending acceptance or rejection from any recipient, the event remains scheduled for the user who sent the invitation.

In a third example, the user's device receives text in an incoming text message or while using a web-based chat application. The received text includes an inquiry from a peer device as to whether the user can participate in a video conference at noon. As the user receives the text message, the video conference is a scheduled event for the peer, who has committed to the conference, but remains unscheduled for the user until the user drafts and sends a text response indicating he agrees to the conference at noon or proposes an alternate time for the conference.

In a fourth example, the user drafts a text communication that includes an inquiry as to whether a peer can participate in a video conference at noon. The text communication is an outgoing communication that the user intends to send as a text message or as a comment in an ongoing web-based chat using a social media site. Until the user sends the text from his device, the video conference is an unscheduled event for the user and his device. When the user sends the text, the user is committing to the proposed noon time and the video conference becomes a scheduled event for the user and his device. If the peer responds by agreeing to the noon time, then the event is scheduled for both the user and the peer. If the peer responds by proposing a different time, then the event is scheduled for the peer for the alternate time but the event becomes unscheduled for the user. The proposed video conference will again become scheduled for the user if he agrees to the new time.

While a smartphone is shown at 102, no such restriction is intended or implied as to the type of device to which these teachings may be applied. Other suitable devices include, but are not limited to: personal digital assistants (PDAs); audio- and video-file players (e.g., MP3 players); personal computing devices, such as tablets and laptops; and wearable electronic devices, such as devices worn with a wristband. For purposes of these teachings, a device can be any apparatus that can schedule and be used for participating in events.

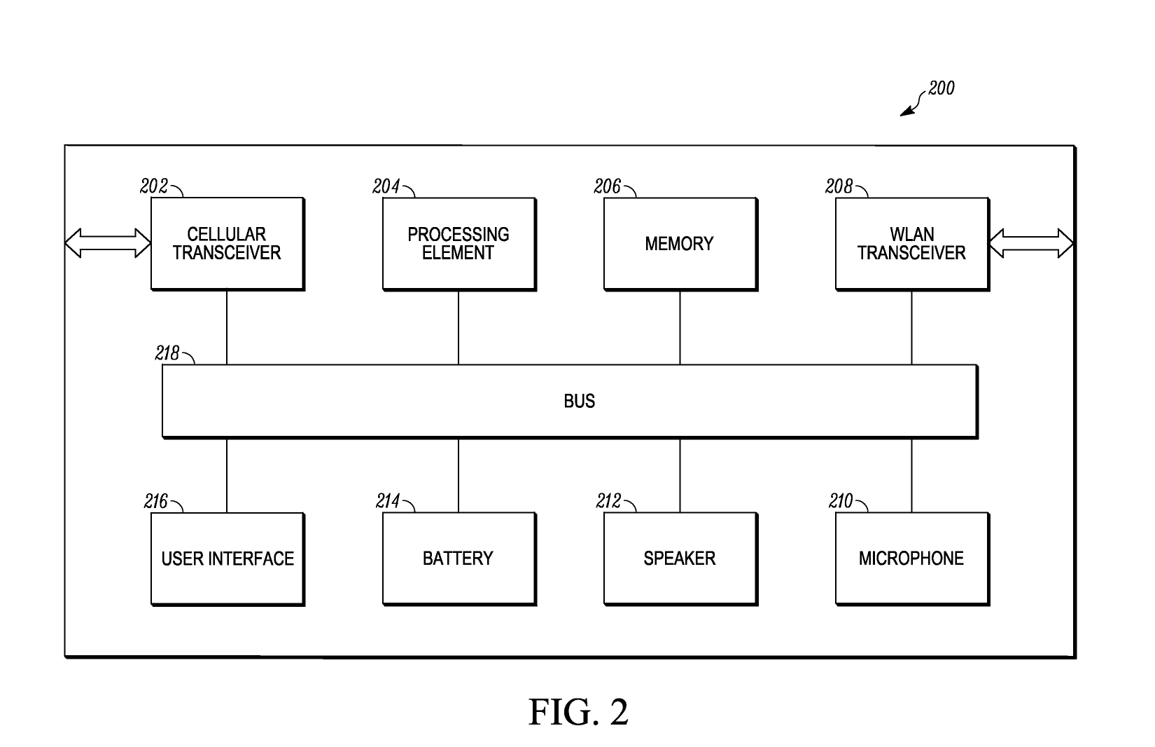

Referring to FIG. 2, a block diagram illustrating some hardware elements of an electronic device in accordance with embodiments of the present teachings is shown and indicated generally at 200. For one embodiment, the block diagram 200 represents some of the elements of the device 102. Specifically, the block diagram 200 shows: a cellular transceiver 202, a processing element 204, memory 206, a wireless local area network (WLAN) transceiver 208, a microphone 210, a speaker 212, a battery 214, and a user interface 216 which are all operationally interconnected by a bus 218.

A limited number of device elements 202, 204, 206, 208, 210, 212, 214, 216 and 218 are shown at 200 for ease of illustration, but other embodiments may include a lesser or greater number of such elements in a device. Moreover, other elements needed for a commercial embodiment of a device that incorporates the elements shown at 200 are omitted from FIG. 2 for clarity in describing the enclosed embodiments.

We now turn to a brief description of the elements within the schematic diagram 200. In general, the processing element 204 and the user interface 216 are configured with functionality in accordance with embodiments of the present disclosure as described in detail below with respect to the remaining figures. “Adapted,” “operative,” “capable” or “configured,” as used herein, means that the indicated elements are implemented using one or more hardware elements such as one or more operatively coupled processing cores, memory elements, and interfaces, which may or may not be programmed with software and/or firmware as the means for the indicated elements to implement their desired functionality. Such functionality is supported by the other hardware shown in FIG. 2, including the device elements 202, 206, 208, 210, 212, 214, and 218.

The processing element 204, for instance, includes arithmetic logic and control circuitry necessary to perform the digital processing, in whole or in part, for the electronic device 102 to manage the scheduling of unscheduled events. For one embodiment, the processing element 204 represents a primary microprocessor, also referred to as a central processing unit (CPU), of the electronic device 102. For example, the processing element 204 can represent an application processor of a smartphone. In another embodiment, the processing element 204 is an ancillary processor, separate from the CPU, wherein the ancillary processor is dedicated to providing the processing capability, in whole or in part, needed for the device elements of the block diagram 200 to perform at least some of their intended functionality.

The memory 206 provides temporary storage of electronic data used by the processing element 204 in performing its functionality. For one embodiment, the memory 206 represents random access memory (RAM). For other embodiments, the memory 206 represents volatile or non-volatile memory used by the processing element 204 to cache data.

The user interface 216 is a means by which an electronic device and a user of the electronic device exchange information. It represents one or more hardware elements that facilitate human-device interaction. By using the user interface 216, the device can provide output to the user and the user can provide input to the device. In a first example, the device uses the user interface 216 to prompt the user to make a selection, and the user uses the user interface 216 to indicate his selection to the device. In a second example, the device uses the user interface 216 to make the user aware of a status of the device, but the device does not await or receive input from the user.

In one embodiment, the user interface 216 represents the touchscreen 104, of the device 102, which visually displays information and receives tactile input. The device 102 prompts the user for input, for instance, by visually displaying the set of options indicated at 112. The user responsively indicates his selection to the device 102 by tapping on or swiping over the option of his choice.

For another embodiment, the speaker 212 and the microphone 210 collectively represent a secondary user interface for a device that is separate from and in addition to the primary user interface 216. For example, the device 102 has the speakers 106 and the microphone 108 in addition to the touchscreen 104. The touchscreen 104 represents the primary user interface 216, while the speakers 106 and microphone 108 represent the secondary user interface. The device 102 can produce an alert by generating an audible tone or message using the speakers 106, and a user can respond by speaking into the microphone 108. The device 102 then uses voice recognition software and/or hardware to interpret the user's spoken message. In a particular embodiment for which a device lacks a touchscreen, the speaker 212 and microphone 210 represent a primary (and possibly the only) user interface. In other embodiments, different hardware elements function as the user interface 216 whereby a device and a user can interact. In a particular embodiment, a device uses a display screen to present output to a user, and the device uses a keypad or keyboard to receive input from the user.

The cellular transceiver 202 enables the device 102 to upload and download data to and from one or more cellular networks. This includes, but is not limited to, the device 102 using a cellular network to send and receive video, voice and/or text data to and from other peer devices with similar capabilities for sending and receiving data. Cellular networks can use any wireless technology that, for example, enables broadband and Internet Protocol (IP) communications including, but not limited to, 3^{rd} Generation (3G) wireless technologies such as CDMA2000 and Universal Mobile Telecommunications System (UMTS) networks or 4^{th} Generation (4G) or pre-4G wireless networks such as LTE and WiMAX.

The WLAN transceiver 208 allows the device 102 direct access to the Internet using standards such as Wi-Fi, which is offered at hotspots. The WLAN transceiver 208 allows the device 102 to send and receive radio signals to and from similarly equipped electronic devices using a wireless distribution method, such as a spread-spectrum or orthogonal frequency-division multiplexing (OFDM) method. For embodiments, the WLAN transceiver 208 uses an IEEE 802.11 standard to communicate with other electronic devices in the 2.4, 3.6, 5, and 60 GHz frequency bands. In a particular embodiment, the WLAN transceiver 208 uses Wi-Fi interoperability standards as specified by the Wi-Fi Alliance to communicate with other Wi-Fi certified devices. Other IEEE 802.11-compliant devices with which the device 102 can communicate include, but are not limited to: wireless access points (WAPs), peer devices, and electronic resources. For one embodiment, a device without a cellular transceiver 202 includes a WLAN transceiver 208 used to send and receive wireless communications with peer devices.

That portion of the cellular transceiver 202 and/or that portion of the WLAN transceiver 208 that allows the device 102 to receive an indication of an unscheduled event from an external device is referred to herein as a receiver element. Similarly, that portion of the cellular transceiver 202 and/or that portion of the WLAN transceiver 208 that allows the device 102 to transmit an indication of an unscheduled event to an external device is referred to herein as a transmitter element.

The battery 214 represents a self-contained power source that supplies electric power to the device elements 202, 204, 206, 208, 210, 212, 216, 218, as needed, during the course of their normal operation. The power is supplied to meet the individual voltage and load requirements of the device elements 202, 204, 206, 208, 210, 212, 216, 218 that draw electric current. For an embodiment, the battery 214 also powers up and powers down the device 102. The battery 214, or any other power source used, is self-contained in that it powers an electronic device independently of any other power source external to the device. For a particular embodiment, the battery 214 is a rechargeable power source. A rechargeable power source for a device is configured to be temporarily connected to another power source external to the device to restore a charge of the rechargeable power source when it is less than fully charged or depleted.

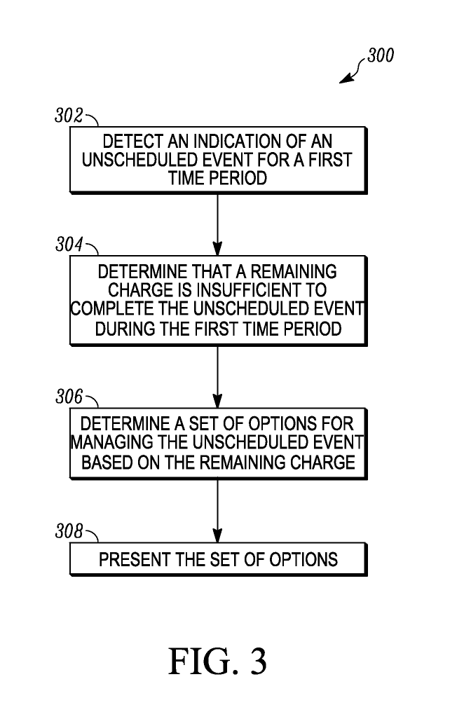

We turn now to a detailed description of the functionality of the device and device elements shown in FIGS. 1 and 2 at 102 and 200, respectively, in accordance with the teachings herein and by reference to the remaining figures. FIG. 3 is a logical flow diagram illustrating a method 300 performed by a device, taken to be device 102 for purposes of this description, for managing the scheduling of unscheduled events. Specifically, the device 102 detects 302 an indication of an unscheduled event for a first time period.

The first time period is the proposed time period for which the unscheduled event is intended when it is detected by the device 102. For example, if the device receives an incoming calendar invitation for a video conference at 10:00 AM, then 10:00 AM is the beginning of the first time period for the unscheduled event. If the device detects that an outgoing calendar invitation is being generated for a video conference at 2:00 PM, then prior to the invitation being sent to one or more peer devices, 2:00 PM is the beginning of the first time period for the unscheduled event. The length of the first time period is the length of time for which the unscheduled event is intended. For example, if the above incoming and outgoing invitations each specify a one-hour video conference, then the length of the first time period is one hour.

The device 102 can detect an indication of an unscheduled event from a number of sources that include, but are not limited to: calendar invitations, e-mails, text messages, task lists, and social media. Contained within a calendar invitation, for example, is a proposed time that accompanies an event to be calendared. The device 102 determines from the invitation the event to be calendared and also the proposed time the event is to be calendared for. For embodiments for which the device 102 can detect an indication of an unscheduled event from an e-mail or a text message, the device 102 parses text contained within the e-mail or text message to determine the nature of and proposed time for the unscheduled event. Using grammatical syntax and comparative algorithms, for instance, the device 102 can identify that an e-mail includes an invitation to an event proposed for a specific time. In parsing text, the device 102 can process text in a main body, a header, or any other portion of a written communication.

For one embodiment, individual words and phrases parsed from the e-mail are compared against a database that identifies language associated with specific events. Words such as “video conference,” “web conference,” or “video chat” within a threshold proximity to a grammatical (e.g., “seven forty”) or numerical (e.g., “7:40”) indication of a time might be interpreted, in isolation or together with other data, to indicate an invitation to participate in a teleconference with video capability at 7:40 PM. For an outgoing e-mail being sent by the device 102, other data might indicate that prior to drafting the e-mail, a user of the device 102 used a web browser to access teleconferencing information or a teleconferencing application via the Internet. Further, the device 102 might determine an increased statistical likelihood that the user intends to schedule a video conference if the device 102 has a compiled history of videoconferencing with one or more recipients of the e-mail.

For other embodiments, the device 102 parses text received from social networking sites, such as Facebook or Google+, when the sites are accessed by the device 102 via the Internet. The text may be from comments previously posted to the social networking sites or the text may be received in real time using a chat feature supported by the social networking sites. For a particular embodiment, the device 102 sends and receives text directly to and from a peer device using short message service (SMS) without the use of an intermediary social networking application.

After detecting 302 an indication of an unscheduled event for a first time period, the device 102 determines 304 that its self-contained power source, assumed for the following embodiments to be the battery 214, has insufficient charge remaining to complete the unscheduled event during the first time period. For an embodiment, determining that the battery 214 has insufficient charge to complete an unscheduled event includes the device 102 determining that the battery 214 presently has insufficient charge to complete the event regardless of the first time period. Assuming the battery 214 has 2200 milliampere-hours (mAh) of usable charge when fully charged, and assuming further that the battery 214 currently has only 150 mAh of charge remaining, the battery 214 has insufficient charge to power a one-hour phone call that requires 170 mAh of charge at any time prior to recharging.

In another embodiment, determining that the battery 214 has insufficient charge to complete an unscheduled event includes the device 102 determining that the battery 214 has insufficient charge remaining to complete the event during a first time period even though the battery 214 may presently have enough charge to complete the event if the event were started immediately. Given the battery 214 has a charge of 200 mAh at 1:00 PM, for example, the device 102 can complete a one-hour phone call requiring 170 mAh if the call is placed at 1:00 PM, but the device 102 cannot complete the call if the call is placed during a first time period that begins at 4:00 PM. This assumes that the device 102 will deplete in excess of 30 mAh of charge from the battery 214 before 4:00 PM.

For an embodiment, determining that the remaining charge for the device 102 is insufficient to complete the unscheduled event is also based on determining an unavailability of a charging opportunity prior to the first time period. For example, when the device 102 cannot recharge prior to the first time period, it cannot acquire the additional charge needed to complete the unscheduled event during the first time period.

For several embodiments, determining that the remaining charge for the electronic device 102 is insufficient to complete an unscheduled event is based on prior use patterns for the device and/or events scheduled for the device. Continuing with the above example, the device 102 determines at 1:00 PM that it will consume more than 30 mAh of charge from the battery 214 before 4:00 PM. In one instance, the device bases this determination upon the fact that another one-hour call is scheduled for the device 102 at 2:30 PM. In another instance, the device 102 bases this determination upon the fact that prior energy-use patterns for the device 102 indicate that charge is depleted from the battery 214 at a rate of 25 mAh per hour during weekday afternoons. Any suitable algorithm can be used to determine the rate at which charge is depleted from the battery 214 and to determine that the battery 214 has insufficient charge to complete an event, without limiting the scope of the present teaching.

When the device 102 determines 304 that it has an insufficient amount of charge remaining to complete the unscheduled event during a first time period, the device determines 306 a set of options for managing the unscheduled event based on the remaining charge. As defined herein, a “set” can be a single element or include multiple elements. The device 102 then presents 308 the set of one or more options using the device 102. For example, the device 102 presents the set of one or more options using the user interface 216 of the device, which in the immediate case is the touchscreen 104.

More specifically, shown at 110 is a pair of icons on the touchscreen 104 of the device 102 indicating an insufficient charge to complete the unscheduled event proposed for the first time period. At 112, the device presents the set of options on the touchscreen 104, with each option represented by a button on the touchscreen 104, as shown. For an embodiment, the user may communicate his selection to the device 102 by tapping on a specific option. In another embodiment, the device 102 implements a default option if the user fails to select an option within a programmed time period of displaying the set of options. For a particular embodiment, the device 102 uses its speakers 106 to generate an audible tone, which accompanies the set of options being displayed at 112, as an additional means of indicating to the user, who might not be viewing the touchscreen 104, that the device 102 is awaiting input.

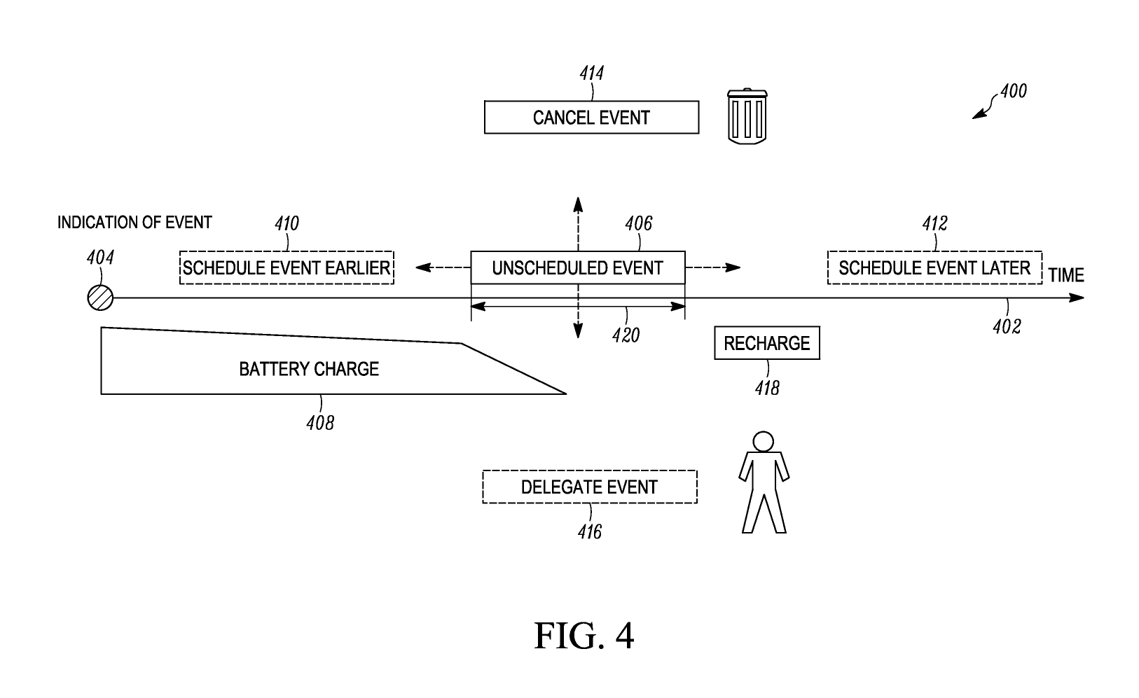

For an embodiment in which a device lacks a touchscreen, the device uses its speaker 212 to audibly present a set of options when it detects an unscheduled event for which it has insufficient charge to complete during a first time period. The user indicates his selection to the device by speaking into the microphone 210. Voice-recognition functionality of the device than processes the captured speech to determine and execute the selected option from the set of options. In another embodiment, a device uses a display to present a set of options to a user, and the user uses a keypad of the device to input his selection. Detailed descriptions of specific options a device can present and implement when there is insufficient charge to complete an unscheduled event during a first time period are provided with reference to FIG. 4

Namely, FIG. 4 is a schematic diagram 400 showing options for scheduling an unscheduled event in accordance with some embodiments of the present teachings. More specifically, FIG. 4 shows a timeline 402 on which an unscheduled event 406 is indicated for a first time period 420. Before the first time period, at 404, the device 102 first detects 302 an indication 404 of the unscheduled event 406. A trapezium shown at 408 represents the charge remaining in the battery 214 of the device 102 as a function of time.

For each time on the timeline 402, the height of the trapezium 408 represents the remaining charge in the battery 214 assuming a priori that the unscheduled event 406 occurs during the first time period 420. The initial negative slope of the trapezium before the first time period 420 results from the battery 214 expending charge as a result of the device 102 being powered on and operating normally. As the first time period 420 begins, the slope of the trapezium 408 becomes increasingly negative, representing the increased load the unscheduled event 406 would place on the battery 214. As can be seen from the right side of the trapezium 408, the battery charge for the device 102 would be depleted before the device 102 could complete the unscheduled event 406 if the unscheduled event 406 were attempted during the first time period 420.

In response to determining 304 the remaining battery charge insufficient to complete the unscheduled event 406 during the first time period 420, the device determines 306 a set of options for managing the unscheduled event 406 based on the remaining charge. Four options for managing the unscheduled event 406 are illustrated in the diagram 400, namely: scheduling 410 the unscheduled event 406 before the first time period 420; scheduling 412 the unscheduled event 406 after the first time period 420; canceling or declining to schedule 414 the unscheduled event 406; and delegating 416 the unscheduled event 406 to another user, and thus to another device. The dotted lines shown at 410, 412, 414, and 416 indicate that each of the four depicted alternatives to scheduling the unscheduled event 406 for the first time period 420 are optional. For an embodiment, which of the four options the device 102 implements in managing the unscheduled event 406 is determined by user selection.

The options 410 and 412 from the set of four options illustrated in the diagram 400 for managing the unscheduled event 406 include scheduling the unscheduled event 406 for a second time period that is different than the first time period. For the option 410, the second time period is before the first time period 420 such that the remaining charge for the electronic device 120 is sufficient to complete the unscheduled event 406 during the second time period. By scheduling 410 the unscheduled event 406 earlier, there is a greater amount of charge in the battery 214 when the second time period begins. Because the battery 214 has more charge when the event begins, the battery 214 has enough charge to allow the device 102 to complete the event during the second time period.

At 10:00 AM, for example, the device 102 detects, at 404, the indication of the unscheduled event 406 for 2:00 PM to 3:00 PM 420, for which the device 102 does not have enough charge to complete. Based on compiled data for the power consumption rate for the unscheduled event type and the currently available charge in the battery 214, the device 102 presents its user with the option 410 of scheduling the unscheduled event 406 for 12:00 PM to 1:00 PM.

The unscheduled event may be an event that involves or does not involve another party. For a particular example continued from above, the unscheduled event 406 is a phone call between a user of the device 102 and a coworker. Because the coworker is a member of the same workgroup as the user, the device 102 has access to the coworker's schedule stored either on a device belonging to the coworker or a separate server. The device 102 queries the coworker's device or the server to determine if the coworker is available from 12:00 PM to 1:00 PM. The device 102 only presents the user with the option 410 of scheduling the unscheduled event 406 for a time during which the coworker shows availability.

In another example, the device 102 determines from a task list (e.g., a “to do” list) a user has stored on the device 102 that the user would like to use the device 102 to view a one-hour video presentation related to his employment during his lunch break at noon. This is an example of an unscheduled event that does not involve another party. The device 102 detects that it has insufficient charge to play or stream the video presentation in its entirety and presents the user with the option of scheduling a viewing of the presentation for an earlier time. In a particular embodiment, the device 102 detects the unscheduled event as the user is typing an entry into his task list.

For the option 412, the device 102 determines that a charging opportunity 418 is available during a third time period, wherein the third time period is after the first time period 420 and before the second time period. At the time 404 the device 102 detects the indication of the unscheduled event 406 and determines the battery 214 does not have enough remaining charge to complete the unscheduled event 406 during the first time period 420, the device 102 determines if a charging opportunity is available during a third time period after the first time period. Such a charging opportunity allows the device 102 to acquire enough charge to complete the unscheduled event 406 during a second time period that occurs after the device 102 recharges.

In one embodiment, the device 102 determines that the recharging opportunity 418 is available during the third time period from a compiled history of charging activity for the device. For example, at 10:00 AM the device 102 detects, at 404, the indication of the unscheduled event 406 for 2:00 PM to 3:00 PM 420, for which the device 102 does not have enough charge to complete. The device 102 has compiled data indicating that the device is plugged into a charger every day at 4:00 PM for a charging opportunity 418. Based on this information, the device presents its user with the option of scheduling the unscheduled event 406 for the later time period of 5:00 PM to 6:00 PM.

In an alternate embodiment to the one presented above, the device 102 determines (e.g., from compiled GPS coordinates) that it arrives at the user's residence every day at 4:00 PM. A compiled charging history, however, does not show that the device 102 is regularly recharged at 4:00 PM. Nonetheless, based on the availability of the charging opportunity at 4:00 PM, if needed, the device presents the option of scheduling the unscheduled event 406 at the later time of 5:00 PM. The device 102 may further display or otherwise present the need to connect the device 102 to a charger at 4:00 PM in order for the device 102 to have sufficient charge to complete the later scheduled event.

For the options of 410 scheduling the unscheduled event 406 earlier or 412 scheduling the unscheduled event 406 later, whether the indication of the unscheduled event 406 was generated or received by the device 102 at 404, the user selecting either the option 410 or 412 confirms the scheduling of the unscheduled event 406. When the user selects option 410, the unscheduled event 406 becomes a scheduled event for a second time period occurring before the first time period 420, and when the user selects option 412, the unscheduled event 406 becomes a scheduled event for a second time period occurring after the first time period 420.

For some embodiments, an option in the set of options for managing the unscheduled event 406 when the device 102 has insufficient charge to complete the unscheduled event at an intended time includes declining to schedule the unscheduled event 406. This option is illustrated in the diagram 400 at 414. Not scheduling the unscheduled event 406 at all prevents the device 102 from beginning the event during the first time period 420 and being unable to complete the event. The phrases “declining the unscheduled event 404” and “canceling the unscheduled event 404” are used herein synonymously. Each phrase includes declining an invitation to the unscheduled event 406 when the invitation is an incoming invitation being received by the device 102. Each phrase also includes canceling an invitation before it is sent by the device 102 when the invitation to the unscheduled event 406 is an outgoing invitation.

In one embodiment, the device 102 presents 308 the option 414 of declining the unscheduled event 406 together with the options 410 and 412, respectively, of scheduling the unscheduled event 406 for a second time period occurring either before or after the first time period 420. From this set of presented options, the user can select the option that the device 102 implements.

In another embodiment, the options 410 and 412 are not included with the option 414 in the set of options for managing the unscheduled event 406. For example, at 2:00 PM, the device 102, at 404, detects the indication of the unscheduled event 406 for 2:30 PM to 3:30 PM, for which the device 102 does not have enough charge to complete. Further, based on compiled charging and location histories for the device 102, the device 102 determines it may not be recharged until 10:00 PM. In this case, there is insufficient time available to schedule the unscheduled event 406 earlier and there are no determinable charging opportunities available after which the unscheduled event 406 can be scheduled. In an additional embodiment, the device 102 determines based on scheduled times of other events that the unscheduled event 406 cannot be rescheduled for a second time period that is different than the first time period 420.

Accordingly, for some embodiments, an option in the set of options for managing the unscheduled event 406 includes delegating the event to another electronic device. This option is indicated in the diagram 400 at 416. The delegation option 416 can be included in the set of options for managing the unscheduled event 406 when the nature of the unscheduled event 406 is such that it cannot or should not be rescheduled. In a first example, the unscheduled event 406 detected at 404 is for the user of the device 102 to bid in place of an unavailable friend who would like to win an auction ending during the first time period 420. Unfortunately, the device 102 has insufficient charge to place bids during the first time period 420, and the close of the auction cannot be rescheduled. In this situation, the user delegates the bidding to a mutual friend, and thus to another device.

In a second example, the user of device 102 is unable to use his device to videoconference with a client at a proposed time due to the device 102 having insufficient charge. To accommodate the client's schedule, the user delegates the videoconferencing event to a coworker who is familiar with the client's case.

In presenting the option 416 of delegating the unscheduled event 406 to another device, the device 102 might also present a contact list from which the user can select a mutual friend or coworker. When the device 102 receives input using the user interface 216 indicating a mutual friend or coworker to which the unscheduled event 406 should be delegated, the device 102 forwards the invitation for the unscheduled event 406 to a recipient device, for accessing by the mutual friend or coworker indicated. Upon receiving an acceptance to the forwarded invitation, the device 102 indicates using the user interface 216 that the unscheduled event 406 has been successfully managed.

For a group of embodiments, the device 102 also includes additional options within the set of options for managing the unscheduled event 406 in combination with, or in place of, the options 410, 412, 414, and 416. In a first embodiment, an option in the set of options for managing the unscheduled event 406 includes altering an operational characteristic of the electronic device 102 to reduce power consumption of the electronic device 102 prior to the first time period 420. Operational characteristics of a device, as used herein, are parameters that govern the functioning of a device that set, control, or otherwise affect the rate at which the device consumes power while operating. Altering an operational characteristic to reduce the power consumption of the device 102, for example, can include turning off the WLAN transceiver 208 while the device 102 is using its cellular transceiver 202 to connect to a cellular network. Further examples include the device 102 dimming and/or reducing the resolution of its display 104, shutting down running applications, and reducing an audio quality setting. In each case, the altered operational characteristic extends the amount of time that the device 102 can continue to operate on its remaining charge.

For a first embodiment, the device 102 determines that it has insufficient charge to complete the unscheduled event 406 during the first time period 420. The device 120 also determines that by altering its operational characteristics, it can complete the unscheduled event during the first time period 420. The device 102 responsively reduces its screen resolution, shuts down a running application, and schedules the unscheduled event 406 for the first time period 420.

In a second embodiment for which the device 102 has insufficient charge remaining to complete the unscheduled event 406 during the first time period 420, an option in the set of options for managing the unscheduled event includes scheduling the unscheduled event for a second time period that is earlier the first time period. The option also includes altering an operational characteristic of the device 102 to reduce power consumption of the device 102 prior to the second time period. By combining the reduced power consumption that results from changing an operational characteristic for the device 102 with the device scheduling the unscheduled event 406 for a second time period that is earlier than the first time period 420, the device 102 can schedule the second time period closer to the first time period 420 than it could if the device had not reduced its power consumption by changing the operational characteristic prior to the second time period.

For a third embodiment, an option in the set of options for managing the unscheduled event 406 includes altering a characteristic of a scheduled event to reduce power consumption of the scheduled event. In a first example, at 404, the device 102 detects an indication at 10:00 AM of the unscheduled event 406 proposed for a first time period 420 beginning at 2:00 PM. The device 102 presents the option of changing a video call, which is scheduled for 11:00 AM, into an audio-only call to conserve enough battery charge to schedule the unscheduled event 406 for the first time period 420. In a second example, the device presents its user with the option of making the video call scheduled for 11:00 AM an audio-only call and also scheduling the unscheduled event 406 for a second time period beginning at 1:00 PM. Without altering a characteristic of the scheduled event, the latest the device can schedule the unscheduled event 406 and still complete the event is 12:00 PM.

For a fourth embodiment, an option in the set of options for managing the unscheduled event 406 includes altering a characteristic of the unscheduled event 406 to reduce power consumption of the unscheduled event itself For example, at 404, the device 102 detects an indication at 10:00 AM of the unscheduled event 406 proposed for a first time period 420 beginning at 2:00 PM, wherein the unscheduled event 406 is a one-hour video conference. Although the device 102 determines that its battery 214 has insufficient charge to complete a one-hour video conference during the first time period 420, the device 120 further determines that it could complete the conference in an audio-only mode. The device 102 responsively presents the option of scheduling the unscheduled event 406 during the first time period 420 without video capability.

In a fifth embodiment, an option in the set of options for managing the unscheduled event 406 includes unscheduling a scheduled event to make a greater amount of battery charge available for the unscheduled event 406. For example, at 404, the device 102 detects an indication at 10:00 AM of the unscheduled event 406 proposed for a first time period 420 beginning at 2:00 PM, wherein the unscheduled event 406 is a business call relating to important contract negotiations. The device 102 presents the option of canceling a social call scheduled during the user's lunch break at 12:00 PM. With the social call canceled, the device has sufficient charge to complete the business call during the first time period 420 without having to alter any characteristics of the business call or any device operational characteristics.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method performed by an electronic device to manage scheduling of unscheduled events, the method comprising:
detecting an indication of an unscheduled event for a first time period;
determining that a remaining charge for the electronic device is insufficient to complete the unscheduled event during the first time period;
determining, based on the remaining charge, a set of options for managing the unscheduled event; and
presenting the set of options using the electronic device.

2. The method of claim 1, wherein determining that the remaining charge for the electronic device is insufficient to complete the unscheduled event is based on determining an unavailability of a charging opportunity prior to the first time period.

3. The method of claim 1, wherein:
the indication of the unscheduled event is detected from at least one of:
a calendar invite;
an e-mail;
a text message;
a task list; or
social media; and
determining that the remaining charge for the electronic device is insufficient to complete the unscheduled event is based on at least one of:
prior use patterns for the device; or
events scheduled for the device.

4. The method of claim 1, wherein the indication of the unscheduled event is received by the electronic device from an external device, the method further comprising scheduling the unscheduled event in response to receiving a user-selected option from the set of options, which confirms the scheduling of the unscheduled event.

5. The method of claim 1, wherein the indication of the unscheduled event is generated by the electronic device, the method further comprising sending the indication of the unscheduled event to an external device in response to receiving a user-selected option from the set of options, which confirms the scheduling of the unscheduled event.

6. The method of claim 1, wherein an option in the set of options for managing the unscheduled event comprises scheduling the unscheduled event for a second time period that is different than the first time period.

7. The method of claim 6, wherein the second time period is before the first time period such that the remaining charge for the electronic device is sufficient to complete the unscheduled event during the second time period.

8. The method of claim 6 further comprising determining that a charging opportunity is available during a third time period, wherein the third time period is after the first time period and before the second time period.

9. The method of claim 1, wherein an option in the set of options for managing the unscheduled event comprises declining to schedule the unscheduled event.

10. The method of claim 1, wherein an option in the set of options for managing the unscheduled event comprises delegating the event to another electronic device.

11. The method of claim 1, wherein an option in the set of options for managing the unscheduled event comprises at least one of:
altering a characteristic of the unscheduled event to reduce power consumption of the unscheduled event; or
altering a characteristic of a scheduled event to reduce power consumption of the scheduled event.

12. The method of claim 1, wherein an option in the set of options for managing the unscheduled event comprises altering an operational characteristic of the electronic device to reduce power consumption of the electronic device prior to the first time period.

13. The method of claim 1, wherein an option in the set of options for managing the unscheduled event comprises scheduling the unscheduled event for a second time period that is earlier the first time period and altering an operational characteristic of the electronic device to reduce power consumption of the electronic device prior to the second time period.

14. The method of claim 1, wherein an option in the set of options for managing the unscheduled event comprises unscheduling a scheduled event.

15. An electronic device configured to manage scheduling of new events, the electronic device comprising:
a self-contained power source configured to power the electronic device;
a user interface; and
a processing element coupled to the self-contained power source and the user interface, wherein the processing element is configured to:
detect an indication of an unscheduled event for a first time period;
determine that a remaining charge for the self-contained power source is insufficient to complete the unscheduled event during the first time period;
determine, based on the remaining charge, a set of options for managing the unscheduled event; and
present the set of options and receive a user-selected option from the set of options using the user interface.

16. The electronic device of claim 15 further comprising a receiver element coupled to the processing element, wherein the receiver element is configured to receive the indication of the unscheduled event from an external device, and wherein the processing element is further configured to schedule the unscheduled event in response to receiving the user-selected option, which confirms the scheduling of the unscheduled event.

17. The electronic device of claim 15 further comprising a transmitter element coupled to the processing element, wherein the transmitter element is configured to transmit the indication of the unscheduled event to an external device.

18. The electronic device of claim 17, wherein the processing element is further configured to control the transmitter element to transmit the indication of the unscheduled event to the external device in response to the user-selected option, which confirms scheduling of the unscheduled event.

19. The electronic device of claim 15, wherein the processing element is further configured to perform a user-selected option from the set of options for managing the unscheduled event, wherein the user-selected option comprises one of:
declining to schedule the unscheduled event;
delegating the unscheduled event to another electronic device;
scheduling the unscheduled event for a second time period before the first time period when the remaining charge for the electronic device is sufficient to complete the unscheduled event; or
scheduling the unscheduled event for a second time period after the first time period based on the availably of a charging opportunity after the first time period.

20. The electronic device of claim 15, wherein the processing element is further configured to perform a user-selected option from the set of options for managing the unscheduled event, wherein the user-selected option comprises at least one of:
altering a characteristic of the unscheduled event to reduce power consumption of the unscheduled event;
altering a characteristic of a first scheduled event prior to the unscheduled event to reduce power consumption of the scheduled event; or
unscheduling a second scheduled event prior to the unscheduled event to reduce power consumption of the electronic device.
